(19) United States
(12) Patent Application Publication
(10) Pub. No.: US 2022/0306874 A1
(43) Pub. Date: Sep. 29, 2022

(54) IMPREGNATED POROUS POWDER WITH SUPERHYDROPHOBIC PARTICLES AND PREPARATION METHOD AND APPLICATION THEREOF

(71) Applicant: SOUTHEAST UNIVERSITY, Nanjing (CN)

(72) Inventors: Youfa ZHANG, Nanjing (CN); Wancheng GU, Nanjing (CN); Yu ZHANG, Nanjing (CN); Xinquan YU, Nanjing (CN)

(21) Appl. No.: 17/834,820

(22) Filed: Jun. 7, 2022

(30) Foreign Application Priority Data
Jun. 29, 2021 (CN) 202110724235.5

(51) Int. Cl. C09D 7/62; C09C 3/00; C09C 3/12; C09C 3/04; C09C 1/00; C09D 7/40; C09D 7/20; C09D 7/45; C09D 7/65; C09D 5/03; C09D 5/44; C09D 163/00

(52) U.S. Cl. CPC C09D 7/62; C09C 3/006; C09C 3/12; C09C 3/043; C09C 1/0087; C09D 7/70; C09D 7/20; C09D 7/45; C09D 7/65; C09D 5/033; C09D 5/448; C09D 5/4457; C09D 163/00; C01P 2004/64; C01P 2004/62; C01P 2004/32; C01P 2006/16; C01P 2006/12; C01P 2006/14

(57) ABSTRACT

A method comprises: dispersing a nanoparticle sol, ammonia water and a waterborne hydrophobic treatment agent in deionized water to prepare a modified nanoparticle suspension, and obtaining a superhydrophobic modified nanoparticle powder by means of a spray drying process; and adding a porous ceramic micro-powder and a waterborne silane coupling agent into deionized water, then adding the superhydrophobic modified nanoparticle powder, performing constant stirring to prepare a superhydrophobic particle impregnating porous particle suspension, and obtaining the impregnated porous powder with superhydrophobic particles by means of a filter drying process or the spray drying process.

### CROSS REFERENCES

This application is the U.S. national phase of International Application No. PCT/CN/Filed on which designated the U.S. and claims priority to Chinese Application Nos. filed on, the entire contents of each of which are hereby incorporated by reference. This application claims priority to Chinese Patent Application Ser. No. 60/864,925 filed 8 Nov. 2006.

### FIELD OF TECHNOLOGY

The present invention belongs to the technical field of preparation of functional coating materials, and particularly relates to an impregnated porous powder with superhydrophobic particles and a preparation method and an application thereof.

### BACKGROUND

A superhydrophobic surface refers to a solid surface which water drops can roll off under the synergistic effect of the surface rough structure and low surface energy, showing excellent comprehensive performances such as waterproofness, oil-proofness and anti-dust, anti-condensation, drag reduction and corrosion protection (or prevention), and can be widely applied to industrial fields such as waterproofness, oil-proofness and anti-dust of textiles, anti-condensation and anti-frosting of air conditioners, resistance to bacterial mildew of building materials, oil-water separation, anti-bioadhesion interfaces and water harvesting systems. However, under the attack of external environments such as external mechanical forces (abrasion and impact), condensation and frosting, the most crucial features for constructing superhydrophobic surfaces, rough structure and low surface energy substance, are easily damaged, so that the superhydrophobicity deteriorates or fails, regenerating the difficulty in removing condensate dewdrops and frost. It has been an international frontier research topic in the fields of material science to realize long-term durability of the superhydrophobic surfaces.

It is shown by researches that construction of a hierarchical rough structure similar to the surface of a lotus leaf or a self-similar structure with inner and outer structures consistent in component can improve the stability of the superhydrophobic surface. But the construction process is usually complex. Compared with a conventional superhydrophobic material with the hierarchical roughness and the self-similar structure, an organic superhydrophobic coating has better stability. In 2013, US Rust-Oleum corporation and UltraTech corporation had successfully launched NeverWet and Ultra-Ever Dry superhydrophobic paint products successively for civil and industrial use based on two-layer process of a flexible organic primer coating and a superhydrophobic nanoparticle coating. In 2015, it had been verified by Lu et al in College London on Science that a coating prepared by taking a commercial all-purpose adhesive as a primer coating and a superhydrophobic nanoparticle suspension as an integrated coating showed good mechanical stability in finger scrubbing, sandpaper abrasion and blade scratching. Inspired by this, the research group enhances the strength and adhesive strength of the primer coating by means of resin crosslinking, particle doping and the like, so that the stability of the coating is further improved. Then, in order to enhance the strength of the superhydrophobic coating, researchers obtain a durable coating material with the self-similar structure by one-step coating, i.e., a primer coating and superhydrophobic coating integration process, by adding a small amount of organic binders into nanoparticles or directly synthesizing organic silicon-based novel pure organic or organic-inorganic hybridized paint containing a fluororesin and nanoparticles. For instance, Nature Materials has reported in 2018 in form of cover paper that a pure organic superhydrophobic coating prepared by compounding an epoxy resin, a fluorine-containing polymer, a perfluoropolyether and PTFE particles is relatively flexible and materials can be removed layer by layer when being abraded, so that it is still superhydrophobic after it is subjected to 30-times of tape-peeling and 100 revolution abrasion of an abrasive wheel with 200 g load, and it can further be subjected to high-pressure water jet and continuous aqua regia corrosion. It is lucubrated that the resin primer coating in the primer coating-suphydrophobic coating two-layer process only can play an adhesive action to the bottoms of the superhydrophobic particles, and the surface particles are still easily damaged; it is hard for organic silicon or fluororesin commonly used in the primer coating-suphydrophobic coating integration process to be compatible or bonded with the superhydrophobic particles, resulting in a loose micro-structure and a poor mechanical property. By applying a conventional external force, it is unnecessary to peel the coating to maintain the superhydrophobicity, and by applying a severe external force, the service life of the coating is quite limited.

Inspired by reconstructing superhydrophobicity of organisms such as the lotus leaf in a damaged area by way of wax regeneration, peers have invented various micro-structure and low surface energy substance self-repairing technologies for improving the stability of the superhydrophobic coating. Repair of the micro-structure is mainly realized by means of high molecular polymer deformation, flowing and degradation under stimulation of temperature, humidity, illumination and immersion, so that the process is relatively complex and great in difficulty. Self-repairing performed by spontaneous migration of the low surface energy organic matters stored in a coating body is the most common method. One of the methods is to repair the area as a microcapsule storing the low surface energy substance in the damaged area of the coating cracks under stimulation of external force, illumination and pH. However, as self-repairing will deplete the low surface energy substance gradually, the regeneration times are limited. Another method is that unreacted organic silicon or fluorine-containing organic matter molecules in the coating driven by free energy, entropy change and concentration gradient are spontaneously diffused and migrated to the damaged area to generate dynamic bonds such as hydrogen bonds and ionic bonds to repair. Without material consumption, the service life of the coating is generally long under the action of a conventional external force. For instance, according to a coating prepared by blending a fluorine-containing polyurethane elastomer (FPU) and fluorine-containing polysilsesquioxane (F-POSS) with a glass point lower than room temperature by the Tuteja research group of University of Michigan, in an abrasion period of 250 g load of an elastic abrasive wheel, F-POSS molecules migrate for self-repairing continuously by means of intermittent heating, so that the coating can still be kept superhydrophobic after 5000 r. It is needed to point out that the self-repairing technology based on the organic coating material not only needs a certain conditioned stimulation with a long room temperature consumed time, but also is hard to avoid severe loss due to external force action. The weight loss of the FPU-F-POSS coating (thickness is 100 m) in the above-mentioned optimal proportion reaches up to 32% after it is loaded by 100 r at 250 g by an abrasion tester. How to construct the superhydrophobic coating which is excellent in mechanical property, firm to combine and capable of being self-repaired rapidly has become a difficulty to research the superhydrophobic materials.

A relatively ideal mechanically stable superhydrophobic coating shall internally have a tightly combined self-similar structure, and the bottom layer shall be firmly combined with a matrix. In combination with an instantaneous in-situ self-repairing function, the surface has a stable rough structure. Meanwhile, in order to apply the coating to the fields of maritime work, oil recovery, heat exchange, aircrafts, low-temperature engineering and the like, it is further needed to have excellent performance such as corrosion resistance, scale prevention, ice prevention, pollution prevention and dragreduction.

The research group has provided a highly wear-resistant normal temperature cured superhydrophobic coating by integrating superhydrophobic particles and primer and a preparation method previously (a compare document CN110003735 A). The method mainly included the steps of grading and modifying diatomite particles and nanoparticles in an ethanol solution first; then performing rotary evaporation and freeze drying to prepare a superhydrophobic graded particle powder; and finally, adding the powder, together with low surface energy fluorocarbon resin and a curing agent thereof, into volatile diluents such as ester, ketone, benzene and ether, and performing coating, film-forming and curing to obtain the superhydrophobic coating with certain wear resistance. However, the coating is still a porous structure. The power falls severely under the action of a mechanical external force, and the environmental stability is poor, so that it is hardly to use the coating on a large scale.

Compared with completely modified superhydrophobic particles, semi-modified or lowly modified porous nanoparticles having larger specific surface areas and abundant active groups can form chemical bonding with an adhesive so as to obtain the superhydrophobic coating with excellent mechanical performance. Meanwhile, in combination of release of the impregnating nanoparticles, when the coating is damaged, the damaged structure on the surface and chemical properties can be instantaneously repaired in situ, so that the coating has nearly all performance needed to resist external force damage, for example, extremely excellent weather resistance, high hardness, wear resistance, water resistance and the like, and the superhydrophobic particles are suitable for preparing a long-term superhydrophobic coating. At present, there is no public data that reports related coatings. Actually, only the long-term superhydrophobic coating that is mechanically and environmentally stable can be widely applied in a true sense, which is the most central and difficult problem for the kind of technologies at present.

### SUMMARY

Technical problem to be solved: in order to solve the ubiquitous problems of wide use of organic solvents, tedious process, poor formula adaptability, poor mechanical performance, poor environmental stability and the like when the existing method is used to prepare the superhydrophobic coating, the present invention provides an impregnated porous powder with superhydrophobic particles and a preparation method and an application thereof. Crucial problems that in a conventional method, a film forming substance is hardly bonded with the superhydrophobic particles, the coating is hardly self-repaired and is poor in long residual action and the like are solved by selecting and controlling a formula and a process, so that the mechanical performance and the environmental stability of the coating are improved remarkably, the coating shows excellent corrosion resistance, damp heat prevention, energy conservation and consumption reduction and is suitably prepared and produced on a large scale, and the superhydrophobic coating technology is truly and widely applied.

A technical solution: a preparation method of a superhydrophobic particle loading porous powder includes the following steps: (1) dispersing 1-12 units _{[J1]}by mass of a nanoparticle sol, 2-10 parts by mass of ammonia water and 1-2 parts by mass of a waterborne hydrophobic treatment agent in 60-100 parts by mass of deionized water and performing constant stirring for 12-48 h to prepare a modified nanoparticle suspension, and obtaining a superhydrophobic modified nanoparticle powder by means of a spray drying process, wherein the nanoparticle sol is at least one of an aluminum oxide nanoparticle sol, a titanium dioxide nanoparticle sol and a silicon dioxide nanoparticle sol with a particle size of 1-200 nm, a solid content of 15-30 wt. % and a pH value of 8-9; and the waterborne hydrophobic treatment agent is one of a waterborne perfluorodecyl siloxane oligomer or a waterborne propyloctyl siloxane oligomer or an emulsion formed by mixing alkyl siloxane with a cationic or nonionic perfluoroacrylic surfactant, a mixing mass ratio of alkyl siloxane to the surfactant is (1-3):1; and (2) adding 1-18 parts by mass of a porous ceramic micro-powder and 0.1-0.5 part by mass of a waterborne silane coupling agent into 60-100 parts by mass of deionized water or adding 1-18 parts by mass of a porous micron ceramic powder, 2-10 parts by mass of ammonia water, 0.4-1 part by mass of a waterborne hydrophobic treatment agent and 0.1-0.5 part by mass of a waterborne silane coupling agent into 60-100 parts by mass of deionized water, performing constant stirring for 12-48 h, then adding 1-5 parts by mass of the superhydrophobic modified nanoparticle powder obtained in the step (1), and performing constant stirring for 12-48 h to prepare a superhydrophobic particle impregnating porous particle suspension, and obtaining the impregnated porous powder with superhydrophobic particles by means of a filter drying process or the spray drying process, wherein the porous ceramic micro-powder is at least one of diatomite particles, silicon dioxide particles, aluminum oxide particles and zirconium oxide particles with a particle size of 1-75 m, or porous ceramic particles prepared by performing high-temperature sintering by taking the diatomite particles, silicon dioxide particles, aluminum oxide particles and zirconium oxide particles as a raw material.

The above-mentioned modified nanoparticle suspension can further be one of nanoparticle emulsions containing polytetrafluoroethylene, polystyrene, polypropylene or high density polyethylene with a solid content of 30 wt. % and a pH value of 8-9.

The above-mentioned filter drying refers to suction filtration of the porous particle suspension under a condition of a vacuum degree of 0.02 MPa or centrifugal separation of the porous particle suspension at a rotating speed of 6000 rpm, and drying of filtered slurry for 1-2 h at 80-120° C.; and the spray drying process refers to spray drying for 1-2 h under conditions of an inlet temperature of 160-220° C., a spraying air pressure of 0.3 MPa and a moisture evaporation capacity of 1-200 L/h.

The above-mentioned waterborne perfluorodecyl siloxane is Evonik Dynasylan F8815, the waterborne propyloctyl siloxane oligomer is Evonik Protectosil WS 670, and alkyl siloxane can be any one of tridecafluorotriethoxy silane, isobutyltriethoxy silane or proyltriethoxy silane.

The above-mentioned porous ceramic micro-powder is flaky, columnar, disciform or spherical with a pore diameter of 20 nm to 2 m, a specific surface area of 40-200 m²/g and a pore volume of 0.08-1.2 cm³/g.

According to the impregnated porous powder with superhydrophobic particles prepared by the above-mentioned method, the particle size is 1-75 m, the specific surface area is 10-80 m²/g and the pore volume is 0.02-0.6 cm³/g, and the dried powder is hydrophilic and is superhydrophobic if being heated for 1-2 h at 150-250° C.

An application of the above-mentioned impregnated porous powder with superhydrophobic particles in preparation of paint of coatings.

The application includes the following preparation steps: (1) oily or waterborne paint: mechanically stirring and dispersing 0.1-10 parts by mass of an impregnated porous powder with superhydrophobic particles in 10-30 parts by mass of a volatile organic solvent or deionized water; upon preparation of the waterborne paint: directly using 1-40 parts by mass of an impregnated porous powder with superhydrophobic particles, then adding 2-10 parts by mass of a film forming matter, 1-4 parts by mass of a curing agent and 0.05-0.4 part by mass of an acrylate copolymer as a dispersant, 0.1-0.5 part by mass of an adhesion promoter, 0.1-0.5 part by mass of a silane coupling agent and 0.1-0.5 part by mass of propylene glycol methyl ether acetate as a stabilizer, and mechanically stirring the mixture for 10 min to obtain the superhydrophobic paint; and coating any cleaned substrate surface with the superhydrophobic coating by way of spraying, dip-coating, roller coating or brush coating, and placing the substrate in an oven at 150-250° C. to be heated and dried for 1-2 h to obtain a superhydrophobic coating, wherein the volatile organic solvent is at least one of ketone, alcohol, ester, fluorocarbon and ether; the film forming matter is at least one of a fluorocarbon resin with low surface energy, organic silicon and a modified resin thereof or a non-hydrophobic acrylic resin, epoxy resin, polyurethane resin, ceramic bond, waterborne acrylic resin or waterborne polyurethane resin; the adhesion promoter is at least one of amino siloxane, alkyl siloxane or a methyl siloxy copolymerized resin; the acrylate copolymer is at least one of polyacrylate, an alkyl acrylate copolymer and an acrylate-acrylic acid copolymer; one end of the silane coupling agent is amino and the other end thereof is ethoxyl or methoxyl; and the curing agent is at least one of isocyanate, fatty amine, aromatic amine and acylamino amine; (2) powder paint: putting 0.1-10 parts by mass of an impregnated porous powder with superhydrophobic particles and 2-8 parts by mass of a binder powder in a ball mill to be ball-milled, putting the powders into a mold to be heated and melted, and performing pulverization for 5-10 min by using a multifunctional pulverizer after cooling to obtain superhydrophobic powder paint with a size of 15-48 m; and electrostatically spraying the prepared powder to a metal substrate, putting the metal substrate in the oven to be cured at a high temperature of 150-250° C. for 10-20 min, and cooling the metal substrate to room temperature to obtain the superhydrophobic coating, wherein the binder powder is at least one of a polyester resin powder, an epoxy resin powder, a polyurethane resin powder and a fluorocarbon resin powder, and the ball milling refers to putting the mixed powders in a ball-milling tank, then adding zirconium oxide ball-milling beads with particle sizes of 1-1.4 mm and performing ball-milling for 4-12 h with a rotating speed of the ball mill being kept at 30-300 r/min; and (3) electrophoretic paint: diluting 2-10 parts by mass of electrophoretic paint 5-10 times with deionized water, adding 0.1-10 parts by mass of a impregnated porous powder with superhydrophobic particles into the solution by taking 0.05-0.4 part by mass of an acrylate copolymer as a dispersant, mechanically stirring the solution for 30 min, performing electrophoretic deposition for 10-30 min at a condition of a direct current voltage of 30-40 V, and then putting the mixture in the oven at 150-250° C. to be heated and dried for 1-2 h to obtain the superhydrophobic coating, wherein the electrophoretic paint is at least one of epoxy electrophoretic paint, acrylic electrophoretic paint and polyurethane electrophoretic paint; and the acrylate copolymer is at least one of polyacrylate, an alkyl acrylate copolymer and an acrylate-acrylic acid copolymer.

The present invention has the beneficial effects that (1) the freshly prepared impregnated porous powder with superhydrophobic particles is hydrophilic, has very good universality and can be added into various film forming matters including a solvent-free, oily or water-base resin, powder paint, electrophoretic paint and the like as a functional filler, and hydrophilic components are decomposed after the powder is subjected to high-temperature curing, so that the coating is superhydrophobic; (2) the impregnated porous powder with superhydrophobic particles takes semi-modified or original porous microparticles as a carrier, so that on the one hand, the superhydrophobic particles impregnate to endow the coating with excellent superhydrophobicity, and on the other hand, the impregnated porous powder with superhydrophobic particles is bonded with various film forming matters, thereby, improving the mechanical performance of the coating, for example, the elasticity modulus, strength, hardness, adhesive strength and wear resistance of the coating is nearly doubled compared with those of a pure coating without the loaded particles; the tangential adhesive strength and the normal adhesive strength of the superhydrophobic coating prepared by the impregnated porous powder with superhydrophobic particles can be improved by 50% or above compared with those of an adhesive and a common superhydrophobic coating; by performing a grid adhesive strength test according to an ISO 2409 standard, the adhesive strength reaches grade 0 in the standard; the tensile strength is improved by 55-100% compared with that of the used adhesive and the common superhydrophobic coating, and the ductility is improved by about 66.7% compared with that of the common superhydrophobic coating; and the durability is improved by 10 times or above compared with that of a common superhydrophobic coating prepared in the prior art, such as a commercial Ultra-ever dry coating and a commercial Neverwet coating, and it can stand against various severe environments; (3) when the coating is damaged, the superhydrophobic nanoparticles stored in the porous powder will be released immediately to repair the damaged area, so that the coating is maintained superhydrophobic; that is, coating repair is performed intelligently and timely in situ, which is totally different from a conventional self-repairing coating, and the latter needs to be stimulated by way of heating, immersing and the like for a certain time; and (4) compared with a compare document CN106478051, the patent is different in application goal, and in the compare document, the heat conductivity coefficient of a diatomite insulating material is reduced by loading an aerogel and the water absorption is reduced by hydrophobic modification, so that the coating is applied to grade A insulation of an exterior wall; the powder prepared by the present invention is mainly used for preparing superhydrophobic paint so as to improve hydrophobicity, corrosion resistance, waterproofness, steam prevention and the like of the coating; the powder provided by the present invention is not needed to be aged for a long time, and the impregnating proportion can be precisely controlled by means of particle addition; in the compare document, an aged mixture is subjected to surface modification with ethanol and organic silane in a large dosage, an alkane solvent normal hexane is used for solvent exchange, and the mixture is cleaned 1-5 times with the alkane solvent; according to the present invention, surface modification is performed in water. The adding proportion of the modifier can be precisely controlled, so that porous ceramic particles including diatomite can be modified inadequately or semi-modified, and the surfaces thereof have hydroxyl groups capable of being bonded with film forming matters in the paint. Meanwhile, the nanoparticle can further be adequately modified, so that the coating is strong in hydrophobicity; in the compare document, the maximum contact angle is 120.7 degrees. The powder provided by the present invention includes modification by fluorine-containing silane, so that the coating is strong in hydrophobicity and lipophobicity. It is pulverized by spray drying, so that it is more convenient. In the compare document, multistage temperature gradient drying is adopted; compared with the highly wear-resistant normal temperature cured superhydrophobic coating by integrating superhydrophobic particles and primer and a preparation method (a compare document CN110003735 A) previously provided by the research group, the present invention is more universal, and can be widely applied to impregnate porous diatomite particles, silicon dioxide particles, aluminum oxide particles and zirconium oxide particles, or porous ceramic particles prepared by performing high-temperature sintering by taking the diatomite particles, silicon dioxide particles, aluminum oxide particles and zirconium oxide particles as a raw material. The used film forming matter can be various resins which not only can be low energy surface fluorocarbon or organic silicon and modified resins thereof, but also can be non-hydrophobic resins or ceramic paint. The paint can be specifically implemented and applied in form of powder paint and electrophoretic paint. The modified system of the present invention is a waterborne system which is more environmental-friendly; adding the porous microparticles such as diatomite is not for grading but for storing and hiding the superhydrophobic nanoparticles by utilizing abundant pore channels of the porous particles, so that the film forming matter can be chemically bonded with participating active groups on porous particle skeletons, and therefore, the strength and compactness of the coating are improved, and there are no problems that the coating is loose and porous, poor in mechanical performance, poor in environmental stability and the like as few active groups on the surfaces of the superhydrophobic nanoparticles in the conventional method cannot be effectively bonded with the resin. In severe environments such as high humidity, low temperature, underwater or salt mist, due to the high compactness and excellent mechanical performance of the coating, it is difficult for moisture and other ions to permeate, so that the matrix is protected. Under a condition of mechanical external force action such as wearing, scraping and engraving, after the film forming matter of the matrix is damaged, the superhydrophobic nanoparticles stored in the porous particles can be released in real time, so that the coating is kept excellent in superhydrophobicity; (6) the coating prepared by applying the superhydrophobic nanoparticle impregnating porous powder has good superhydrophobicity, and the static contact angle of the water drop is greater than 1550 and the roll-off angle is smaller than 10°; the static contact angle of the water drop can still be kept greater than 155° and the roll-off angle can be kept smaller than 10° after it is abraded for 2000 r by using a paint film abrasion tester under a condition of 1000 g load; the static contact angle of the water drop can still be kept greater than 155° and the roll-off angle can be kept smaller than 10° after it is subjected to xenon arc aging test for 2000 h, is immersed in water for 6 months and is tested for 1000 h at a high temperature (85° C.) and high humidity (99%); and the adhesive strength on the surface of the substrate such as a metal and a plastic is good, the adhesive strength of the paint film tested by a grid method is grade 0, and the pencil hardness of the coating can reach 6H; (7) the coating further has multifunctionality, including excellent anti-condensation, anti-frosting, corrosion protection and the like. Compared with a conventional commercial hydrophilic coating heat exchanger, the defrosting performance of a superhydrophobic coating heat exchanger prepared by applying the impregnated porous powder with superhydrophobic particles is more rapid in process with frost layers falling in block and is free of water drop residues; the defrosting energy consumption is lower, and under different working conditions such as condensation, dust contamination, frost formation and defrosting, the efficiencies are higher; compared with anti-corrosive coatings in the market (for example, epoxy resin and fluorocarbon resin coatings) and common superhydrophobic coatings such as Ultra-ever dry and Neverwet coatings, the low frequency modulus of impedance of the superhydrophobic coating is improved by several orders of magnitudes, and the anti-corrosive time thereof is also prolonged by more than 10 times; and under the mechanical external force action, it can be still kept functional in a long time; and (8) the preparation method provided by the present invention has low requirements on material and shape of the substrate, the device is simple and easy to operate, the cost is low, and large area construction can be performed. The work efficiency of the device applying the coating can be improved effectively, for example, it plays remarkable energy-saving and consumption-reducing roles if it is applied to a heat exchanger of air conditioner, can be widely applied to interference prevention of 5G antenna, heavy duty anticorrosion of metal, low-temperature icing prevention, marine pollution prevention, water surface and underwater resistance reduction, pipeline scale prevention, energy conservation and consumption reduction of heat exchanger and the like. It has excellent performance which is hardly achieved in the prior art.

### BRIEF DESCRIPTION OF THE DRAWINGS

FIG. 1a shows macroscopic photographs of suspensions of impregnated porous particles with superhydrophobic particles;

FIG. 1b shows a schematic diagram of the spray drying device;

FIG. 1c shows one example of macroscopic wettability of original porous particles compared with the impregnated porous particles with superhydrophobic particles, which are spray-dried and roasted at a high temperature of 200° C.;

FIG. 1d shows another example of macroscopic wettability of original porous particles compared with the impregnated porous particles with superhydrophobic particles, which are spray-dried and roasted at a high temperature of 200° C.;

FIG. 2a shows a macroscopic wettability of a room temperature cured coating prepared by applying the impregnated porous powder with superhydrophobic particles (nanoparticles are aluminum oxide and microporous particles are porous ceramic particles sintered at high temperature);

FIG. 2b shows a contact angle of a room temperature cured coating prepared by applying the impregnated porous powder with superhydrophobic particles (nanoparticles are aluminum oxide and microporous particles are porous ceramic particles sintered at high temperature);

FIG. 2c shows a macroscopic wettability of a high temperature cured coating prepared by applying the impregnated porous powder with superhydrophobic particles (nanoparticles are aluminum oxide and microporous particles are porous ceramic particles sintered at high temperature);

FIG. 2d shows a contact angle of a high temperature cured coating prepared by applying the impregnated porous powder with superhydrophobic particles (nanoparticles are aluminum oxide and microporous particles are porous ceramic particles sintered at high temperature);

FIG. 3a shows a macroscopic morphology and wettability of a superhydrophobic coating prepared by applying an impregnated porous particle porous powder with superhydrophobic particles (nanoparticles are silicon dioxide and microporous particles are porous ceramic particles sintered at high temperature): macroscopic wettability of a high temperature cured superhydrophobic coating prepared by applying the impregnated porous powder with superhydrophobic particles;

FIG. 3b shows a macroscopic morphology and wettability of a superhydrophobic coating prepared by applying an impregnated porous particle porous powder with superhydrophobic particles (nanoparticles are silicon dioxide and microporous particles are porous ceramic particles sintered at high temperature): a contact angle of the coating;

FIG. 3c shows a macroscopic morphology and wettability of a superhydrophobic coating prepared by applying an impregnated porous particle porous powder with superhydrophobic particles (nanoparticles are silicon dioxide and microporous particles are porous ceramic particles sintered at high temperature): a roll-off angle of the coating;

FIG. 4a is SEM diagrams after and before the impregnated porous particle porous powder with superhydrophobic particles is impregnated: originally high temperature sintered porous ceramic particles;

FIG. 4b is SEM diagrams after and before the impregnated porous particle porous powder with superhydrophobic particles is impregnated: a morphology of a hole thereof amplified;

FIG. 4c is SEM diagrams after and before the impregnated porous particle porous powder with superhydrophobic particles is impregnated: a surface structural diagram of the applied superhydrophobic coating after the impregnated porous powder with superhydrophobic particles is prepared;

FIG. 4d is SEM diagrams after and before the impregnated porous particle porous powder with superhydrophobic particles is impregnated: a morphology of the amplified hole of the impregnated porous particle porous powder with superhydrophobic particles at the time;

FIG. 5a is a surface SEM diagram after mechanical durability and wear of the superhydrophobic coating prepared by applying the impregnated porous powder with superhydrophobic particles: a variation diagram of a contact angle and a rolling angel of the coating along with a Taber abrasion period

FIG. 5b is a surface SEM diagram after mechanical durability and wear of the superhydrophobic coating prepared by applying the impregnated porous powder with superhydrophobic particles: a surface morphology diagram of the coating after 1000 abrasion periods (NEM is a superhydrophobic granular porous powder, FEVE is a fluorocarbon resin, epoxy is an epoxy resin, ceramic paint is a ceramic coating, and a load is 1 kg);

FIG. 6a shows a surface and section structural diagrams of the superhydrophobic coating applying the impregnated porous powder with superhydrophobic particles: a surface morphology;

FIG. 6b shows a surface and section structural diagrams of the superhydrophobic coating applying the impregnated porous powder with superhydrophobic particles: a section morphology, and an illustration is a TEM diagram of the particles impregnating in the porous structure;

FIG. 7a shows SEM diagrams and pore volume variation diagrams applying the impregnated porous powder with superhydrophobic particles before and after impregnating: the SEM diagram of the porous ceramic powder without load;

FIG. 7b shows SEM diagrams and pore volume variation diagrams applying the impregnated porous powder with superhydrophobic particles before and after impregnating: the SEM diagram after impregnating the porous ceramic powder;

FIG. 7c shows SEM diagrams and pore volume variation diagrams applying the impregnated porous powder with superhydrophobic particles before and after impregnating: a diagram of the pore volume with different modified nanoparticle powder impregnating amounts varying along with pore diameter; a mechanical performance diagram of the superhydrophobic coating applying the impregnated porous powder with superhydrophobic particles;

FIG. 8a shows microscopic mechanical performance of the superhydrophobic coating applying the impregnated porous powder with superhydrophobic particles: a surface morphology of the coating scraped under 10 mN load in a microscopic scale;

FIG. 8b shows microscopic mechanical performance of the superhydrophobic coating applying the impregnated porous powder with superhydrophobic particles: a surface morphology of the coating scraped under 100 mN load in a microscopic scale;

FIG. 9a shows wear resistance of the superhydrophobic coating applying the impregnated porous powder with superhydrophobic particles: a contact angle and a roll-off angle of a highly wear-resistant normal temperature cured primer superhydrophobic coating by integrating superhydrophobic particles and primer a preparation method previously (a compare document CN110003735 A) after Taber abrasion;

FIG. 9b shows wear resistance of the superhydrophobic coating applying the impregnated porous powder with superhydrophobic particles: wear resistance of the superhydrophobic coating applying the impregnated porous powder with superhydrophobic particles under a same test condition;

FIG. 9c shows wear resistance of the superhydrophobic coating applying the impregnated porous powder with superhydrophobic particles: the superhydrophobic coating applying the impregnated porous powder with superhydrophobic particles subjected to tests under different severe conditions including RCA tape wearing, sand ablation, high-pressure water jet impact, high speed sandy water ablation and salt solution immersion (FEVE is a fluorocarbon resin with a 1 kg load);

FIG. 10a shows the universality of the superhydrophobic coating applying the impregnated porous powder with superhydrophobic particles: wear resistance of a superhydrophobic coating prepared by an epoxy resin adhesive;

FIG. 10b shows the universality of the superhydrophobic coating applying the impregnated porous powder with superhydrophobic particles: wear resistance of a superhydrophobic coating prepared by a ceramic coating adhesive;

FIG. 10c shows the universality of the superhydrophobic coating applying the impregnated porous powder with superhydrophobic particles: wear resistance of a superhydrophobic coating prepared by an acrylic resin adhesive (NEM@FEVE, NEM@epoxy, NEM@ceramica coating and NEM@acrylic are superhydrophobic coatings applying the impregnated porous powder with superhydrophobic particles prepared by different adhesives, Diatomite@FEVE, Nano-silica@FEVE, Mixed-silica@FEVE and Ultra-ever dry are comparative superhydrophobic coatings, FEVE is a fluorocarbon resin, epoxy is an epoxy resin, ceramic coating is ceramic paint and acrylic is an acrylic resin);

FIG. 11a shows an FTIR (Fourier Transform Infrared Spectrometer) of the superhydrophobic coating applying the impregnated porous powder with superhydrophobic particles, the impregnated porous powder with superhydrophobic particles and the fluorocarbon resin as well as fluorine contents and hydroxyl contents of a superhydrophobic nanopowder, a microporous powder with a low modification degree and the impregnated porous powder with superhydrophobic particles: an FTIR infrared spectrogram;

FIG. 11b shows an FTIR (Fourier Transform Infrared Spectrometer) of the superhydrophobic coating applying the impregnated porous powder with superhydrophobic particles, the impregnated porous powder with superhydrophobic particles and the fluorocarbon resin as well as fluorine contents and hydroxyl contents of a superhydrophobic nanopowder, a microporous powder with a low modification degree and the impregnated porous powder with superhydrophobic particles: a diagram of fluorine contents and hydroxyl contents;

FIG. 12a is a mechanical performance diagram of the superhydrophobic coating applying the impregnated porous powder with superhydrophobic particles: a stress-strain curve;

FIG. 12b is a mechanical performance diagram of the superhydrophobic coating applying the impregnated porous powder with superhydrophobic particles: a morphologic diagram of the stretched superhydrophobic coating applying the impregnated porous powder with superhydrophobic particles;

FIG. 12c is a mechanical performance diagram of the superhydrophobic coating applying the impregnated porous powder with superhydrophobic particles: a nanoindentation curve (NEM@FEVE is the superhydrophobic coating applying the impregnated porous powder with superhydrophobic particles, Diatomite@FEVE, Nano-silica@FEVE and Mixed-silica@FEVE are comparative superhydrophobic coatings, and FEVE is the fluorocarbon resin);

FIG. 13a is an adhesive strength diagram of the superhydrophobic coating applying the impregnated porous powder with superhydrophobic particles: a normal adhesive strength diagram;

FIG. 13b is an adhesive strength diagram of the superhydrophobic coating applying the impregnated porous powder with superhydrophobic particles: a tangential adhesive strength diagram;

FIG. 13c is an adhesive strength diagram of the superhydrophobic coating applying the impregnated porous powder with superhydrophobic particles: a grid test schematic diagram;

FIG. 13d is an adhesive strength diagram of the superhydrophobic coating applying the impregnated porous powder with superhydrophobic particles: a grid test result of the superhydrophobic coating (NEM@FEVE is the superhydrophobic coating applying the impregnated porous powder with superhydrophobic particles, Diatomite@FEVE, Nano-silica@FEVE and Mixed-silica@FEVE are comparative superhydrophobic coatings, and FEVE is the fluorocarbon resin);

FIG. 14a shows a scale prevention property of the superhydrophobic coating applying the impregnated porous powder with superhydrophobic particles: a macroscopic picture of cement slurry solidified on a surface of the coating;

FIG. 14b shows a scale prevention property of the superhydrophobic coating applying the impregnated porous powder with superhydrophobic particles: a macroscopic photo after the cement slurry on the surface of the coating falls off,

FIG. 15a shows an anti-condensation property of the superhydrophobic coating applying the impregnated porous powder with superhydrophobic particles: an integrated microscopic picture;

FIG. 15b shows an anti-condensation property of the superhydrophobic coating applying the impregnated porous powder with superhydrophobic particles: a macroscopic photo;

FIG. 16a shows a frosting prevention property of the superhydrophobic coating applying the impregnated porous powder with superhydrophobic particles: an integrated frost layer growth process microscopically;

FIG. 16b shows a frosting prevention property of the superhydrophobic coating applying the impregnated porous powder with superhydrophobic particles: an integrated frost melting process microscopically, c is a macroscopic frost layer growth process, and d is a macroscopic frost layer melting process;

FIG. 16c shows a frosting prevention property of the superhydrophobic coating applying the impregnated porous powder with superhydrophobic particles: a macroscopic frost layer growth process;

FIG. 16d shows a frosting prevention property of the superhydrophobic coating applying the impregnated porous powder with superhydrophobic particles: a macroscopic frost layer melting process;

FIG. 17a shows a dropwise condensation property of hot water vapor of the superhydrophobic coating applying the impregnated porous powder with superhydrophobic particles: wherein a is a hot water vapor condensation test setting schematic diagram (a steam temperature is 100° C.);

FIG. 17b shows a dropwise condensation property of hot water vapor of the superhydrophobic coating applying the impregnated porous powder with superhydrophobic particles: an optical photo of a time-varying hot water vapor induced condensation behavior;

FIG. 17c shows a dropwise condensation property of hot water vapor of the superhydrophobic coating applying the impregnated porous powder with superhydrophobic particles: variations of the contact angle and the roll-off angle along with the hot water vapor condensation test time of the coating after Taber abrasion (the abrasion period is 200 cycles and the load is 1 kg);

FIG. 17d shows a dropwise condensation property of hot water vapor of the superhydrophobic coating applying the impregnated porous powder with superhydrophobic particles: an optical photo of the time-varying condensation behavior of the abraded coating after 200 cycles of Taber abrasion (the load is 1 kg);

FIG. 18a shows a neutral salt resisting effect of the superhydrophobic coating applying the impregnated porous powder with superhydrophobic particles: a macroscopic photo of different coatings through a neutral salt test;

FIG. 18b shows a neutral salt resisting effect of the superhydrophobic coating applying the impregnated porous powder with superhydrophobic particles: a macroscopic morphology of the superhydrophobic coating applying the impregnated porous powder with superhydrophobic particles after the neutral salt test in 5000 h (i-iv are the superhydrophobic coating applying the impregnated porous powder with superhydrophobic particles prepared by different adhesives, v and vi are fluorocarbon resin and epoxy resin coatings, and vii-ix are comparative superhydrophobic coatings);

FIG. 19a shows a salt solution immersion prevention test of the superhydrophobic coating applying the impregnated porous powder with superhydrophobic particles: low frequency modulus of impedance of different coatings subjected to salt solution immersion;

FIG. 19b shows a salt solution immersion prevention test of the superhydrophobic coating applying the impregnated porous powder with superhydrophobic particles: a variation of the low frequency modulus of impedance of different coatings along with salt solution immersion time;

FIG. 19c shows a salt solution immersion prevention test of the superhydrophobic coating applying the impregnated porous powder with superhydrophobic particles: a variation of an open circuit potential of different coatings along with salt solution immersion time (NEM@FEVE and NEM@epoxy are superhydrophobic coatings applying the impregnated porous powder with superhydrophobic particles prepared by different adhesives, Diatomite@FEVE and Ultra-ever dry are comparative superhydrophobic coatings, FEVE is the fluorocarbon resin coating, and epoxy is an epoxy resin coating);

FIG. 20a is macroscopic morphologic diagrams of an anti-corrosive hydrophobic coating prepared by applying the impregnated porous powder with superhydrophobic particles prepared by a wet spraying process after and before salt spray corrosion: a macroscopic morphology of an initial anti-corrosive hydrophobic coating;

FIG. 20b is macroscopic morphologic diagrams of an anti-corrosive hydrophobic coating prepared by applying the impregnated porous powder with superhydrophobic particles prepared by a wet spraying process after and before salt spray corrosion: a macroscopic morphology of an anti-corrosive hydrophobic coating after 5000 h;

FIG. 21a shows performance of an air-conditioning heat exchanger of the superhydrophobic coating applying the impregnated porous powder with superhydrophobic particles: a defrosting process photo of a superhydrophobic coating heat exchanger applying the impregnated porous powder with superhydrophobic particles and a commercial hydrophilic heat exchanger;

FIG. 21b shows performance of an air-conditioning heat exchanger of the superhydrophobic coating applying the impregnated porous powder with superhydrophobic particles: variations of defrosting energy consumptions of a superhydrophobic coating applying the impregnated porous powder with superhydrophobic particles, a nanoparticle coating and a hydrophilic coating heat exchanger along with time;

FIG. 21c shows performance of an air-conditioning heat exchanger of the superhydrophobic coating applying the impregnated porous powder with superhydrophobic particles: an improved proportion of efficiency of the superhydrophobic coating applying the impregnated porous powder with superhydrophobic particles compared with that of the hydrophilic coating heat exchanger under various working conditions, the various working conditions including condensation, dust contamination, frosting and defrosting;

FIG. 21d shows performance of an air-conditioning heat exchanger of the superhydrophobic coating applying the impregnated porous powder with superhydrophobic particles: a frosting heat exchange amount of the superhydrophobic coating applying the impregnated porous powder with superhydrophobic particles and the nanoparticle coating heat exchanger after dust blowing;

FIG. 21e shows performance of an air-conditioning heat exchanger of the superhydrophobic coating applying the impregnated porous powder with superhydrophobic particles: a defrosting energy consumption of the superhydrophobic coating applying the impregnated porous powder with superhydrophobic particles and the nanoparticle coating heat exchanger after dust blowing;

FIG. 21f shows performance of an air-conditioning heat exchanger of the superhydrophobic coating applying the impregnated porous powder with superhydrophobic particles: efficiency attenuation proportions of the superhydrophobic coating applying the impregnated porous powder with superhydrophobic particles and the nanoparticle coating heat exchanger after dust blowing.

### DETAILED DESCRIPTION OF THE EMBODIMENTS

### Example 1

In the embodiment, inorganic nanoparticles are aluminum oxide, a solvent is water, a hydrophobic modifier is a waterborne propyloctyl siloxane oligomer Evonik Protectosil WS 670, and porous microparticles are high-temperature sintered porous ceramic particles by taking aluminum oxide and silicon dioxide as a raw material. The preparation method includes the following preparation steps:

10 parts by mass of a nano aluminum oxide sol, 5 parts by mass of ammonia water and 1.6 parts by mass of a waterborne propyloctyl siloxane oligomer Evonik Protectosil WS 670 were added into 100 parts by mass of deionized water to be continuously stirred for 24 h to obtain a modified nanoparticle suspension;

the nanoparticle suspension prepared in the step (1) was subjected to spray drying for 1-2 h under conditions of an inlet temperature of 160-220° C., a spray pressure of 0.3 Mpa and a water-evaporation capacity of 1-200 L/h to remove deionized water so as to obtain a nanoparticle powder;

9 parts by mass of porous ceramic particles prepared by high temperature sintering and 0.2 part by mass of Evonik DynasylanHydrosil 1151 amino waterborne siloxane were added into 80 parts by mass of deionized water to be stirred for 12 h and then the modified nano powder prepared in the step (2) was added into the mixture to be continuously stirred for 12 h to prepare an impregnated porous powder with superhydrophobic particles suspension, and then the suspension was subjected to spray drying for 1-2 h under conditions of an inlet temperature of 160-220° C., a spraying air pressure of 0.3 Mpa and a moisture evaporation capacity of 1-200 L/h to obtain a final impregnated porous powder with superhydrophobic particles;

6 parts by mass of the impregnated porous powder with superhydrophobic particles was mechanically stirred and dispersed in 25 parts by mass of water, then 8 parts by mass of waterborne epoxy resin, 0.4 part by mass of polyacrylate as a dispersant, 0.5 part by mass of amino siloxane and 0.4 part by mass of propylene glycol methyl ether acetate as a stabilizer were added, and the mixture was stirred for 10 min to obtain paint applying the porous powder; and

the paint applying the porous powder prepared in the step (4) was coated to a cleaned surface of any substrate, and the substrate was placed in a 200° C. oven to be heated and dried for 1 h to obtain the superhydrophobic coating.

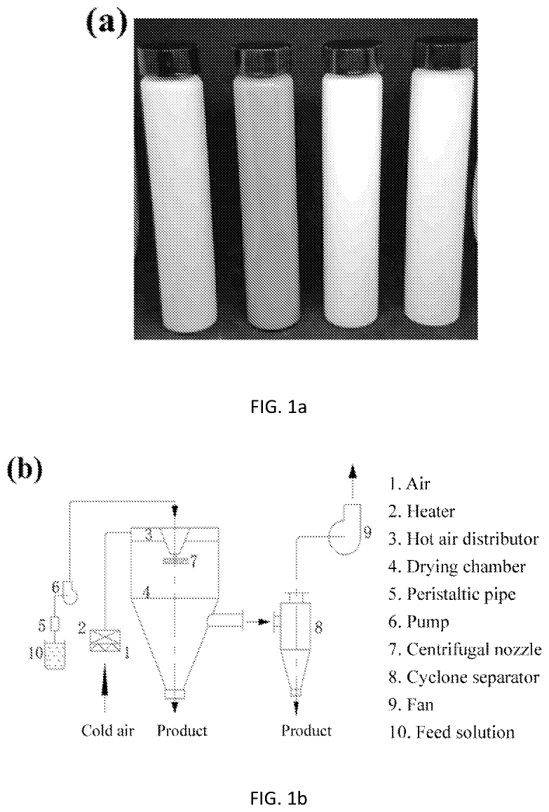

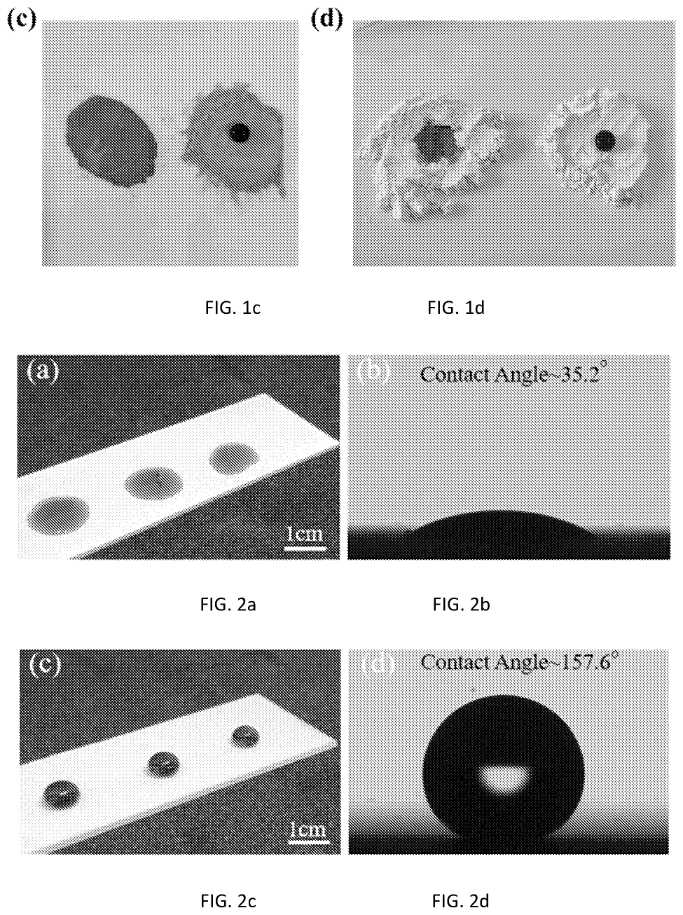

FIG. 1a shows that the impregnated porous powder with superhydrophobic particles suspension is a white suspension, after the power subjected to spray drying is dried at a high temperature, a water drop dyed by methyl blue is spherical on the surface thereof, and compared with an original powder, excellent superhydrophobicity obtained after modification is shown as FIG. 1d; and FIG. 2a-d shows wettability conditions of the coating after room temperature curing and high temperature curing, it can be seen that the coating is hydrophilic when being subjected to room temperature curing, and benefited from breakdown of hydrophilic components at the high temperature, the coating subjected to high temperature curing obtains superhydrophobicity. The contact angle of the water drop on the surface of the coating is greater than 1550 and the roll-off angle is smaller than 5°; and the surface of the coating is continuous, even and intact and is free of defects of nodules, shrinkage cavities, bubbles, pinholes, cracks, peeling, pulverizing, sagging, base exposing, dirt inclusion and the like.

### Example 2

In the embodiment, inorganic nanoparticles are silicon dioxide, a volatile organic solvent is propylene glycol methyl ether, a waterborne hydrophobic treatment agent is waterborne perfluorodecyl siloxane, and porous microparticles are high-temperature sintered porous ceramic particles by taking silicon dioxide, aluminum oxide and zirconium oxide as a raw material. The preparation method includes the following preparation steps:

8 parts by mass of a nano silicon sol, 4 parts by mass of ammonia water and 0.5 part by mass of perfluoroalkyl siloxane were dispersed in 100 parts by mass of deionized water to be continuously stirred for 24 h to prepare a modified nanoparticle suspension;

the superhydrophobic nano paint prepared in the step (1) was subjected to spray drying for 1-2 h under conditions of an inlet temperature of 160-220° C., a spraying air pressure of 0.3 Mpa and a moisture evaporation capacity of 1-200 L/h to remove deionized water so as to obtain a superhydrophobic nanoparticle powder;

4 parts by mass of porous ceramic particles prepared by high temperature sintering and 0.2 part by mass of Evonik DynasylanHydrosil 1151 amino waterborne siloxane were added into 60 parts by mass of deionized water to be stirred for 12 h and then the modified nano powder prepared in the step (2) was added into the mixture to be continuously stirred for 12 h to prepare an impregnated porous powder with superhydrophobic particles suspension, and then the suspension was subjected to spray drying for 1-2 h under conditions of an inlet temperature of 160-220° C., a spraying air pressure of 0.3 Mpa and a moisture evaporation capacity of 1-200 L/h to obtain a final porous powder;

5 parts by mass of the impregnated porous powder with superhydrophobic particles was mechanically stirred and dispersed in 30 parts by mass of propylene glycol methyl ether, then 10 parts by mass of fluorocarbon resin, 4 parts by mass of an aliphatic polyisocyanate curing agent, 0.25 part by mass of polyacrylate as a dispersant, 0.25 part by mass of amino siloxane and 0.2 part by mass of propylene glycol methyl ether acetate as a stabilizer were added, and the mixture was stirred for 10 min to obtain superhydrophobic paint applying the porous powder, and if the fluorocarbon resin and the aliphatic polyisocyanate curing agent were equivalently replaced by epoxy resin and an aliphatic amine curing agent or ceramic paint and the aliphatic polyisocyanate curing agent, paint under different adhesives could be obtained; and

the paint applying the powder prepared in the step (4) was coated to a cleaned surface of any substrate, and the substrate was placed in a 160° C. oven to be heated and dried for 2 h to obtain the superhydrophobic coating.

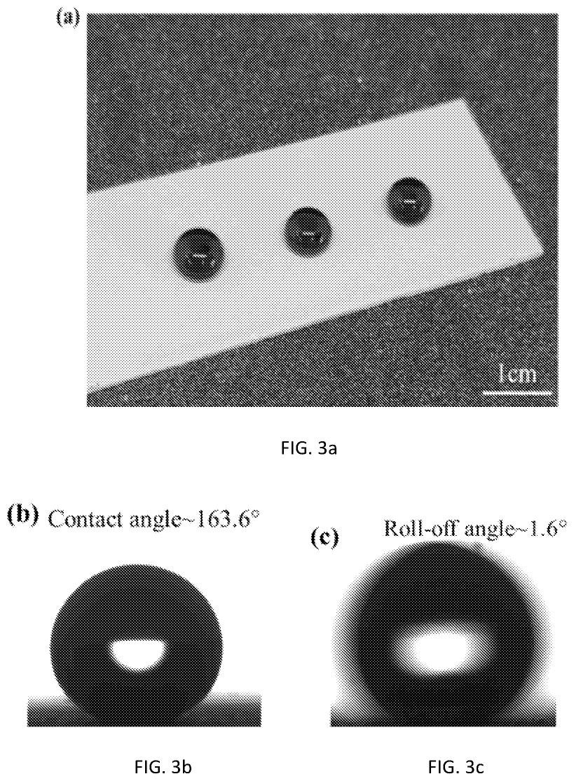

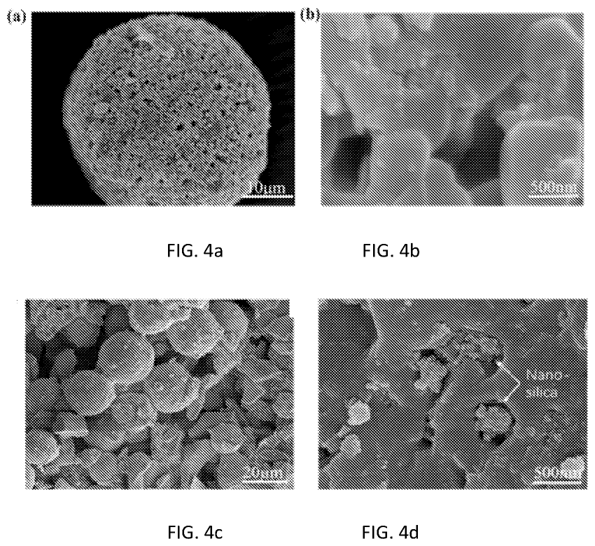

Brick red slurry in FIG. 1c shows a macroscopic morphology of the impregnated porous powder with superhydrophobic particles suspension, after the power subjected to spray drying is dried at a high temperature, a water drop dyed by methyl blue is spherical on the surface thereof, and compared with an original powder, excellent superhydrophobicity obtained after modification is shown; and FIG. 3a-c shows a macroscopic photo and wettability of the superhydrophobic coating applying the impregnated porous powder with superhydrophobic particles, wherein the contact angle of the water drop on the surface of the coating is 163.6°, and the rolling angle thereof is 1.6°. FIG. 4a-d shows morphologies of the original high temperature sintered porous ceramic particles and the prepared superhydrophobic nanoparticle impregnating porous powder in the coating, and it can be seen that nano silicon dioxide is stored in holes of porous ceramic particles and the superhydrophobic nanoparticle impregnating porous powder and the adhesive together form a compact structure in the coating.

### Example 3

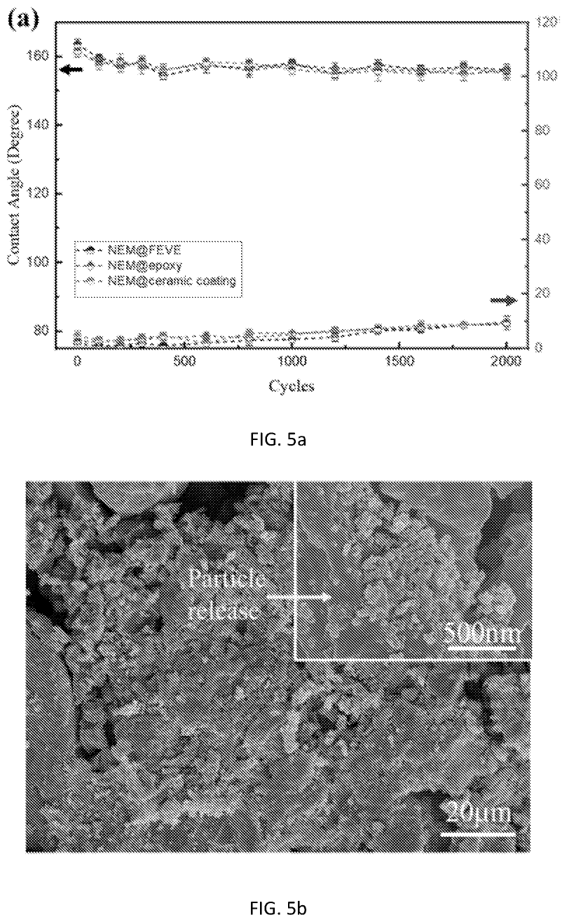

FIG. 5a-b is SEM diagrams of mechanical wear resistance of the superhydrophobic coating prepared by the impregnated porous powder with superhydrophobic particles and a surface subjected to severe mechanical wear in the example 2. Benefited from good dispersibility of the impregnated porous powder with superhydrophobic particles itself and the strong bonding force of the adhesive as well as an armor protection effect of the preferred high strength high temperature sintered porous ceramic particles through a test and release of the superhydrophobic nanoparticles under a condition of severe mechanical damage, the superhydrophobic coating still can keep excellent superhydrophobicity after 2000 r of Taber abrasion (1 Kg load).

### Example 4

In the embodiment, inorganic nanoparticles are silicon dioxide, a volatile organic solvent is butyl acetate, a waterborne hydrophobic treatment agent is waterborne perfluorodecyl siloxane, and porous microparticles are diatomite. The preparation method includes the following preparation steps:

8 parts by mass of a chained nano silicon sol, 2 parts by mass of a spherical nano silicon sol, 6 parts by mass of ammonia water and 2 parts by mass of perfluoroalkyl siloxane were dispersed in 100 parts by mass of deionized water to be continuously stirred for 24 h to prepare a modified nanoparticle suspension;

the superhydrophobic nano paint prepared in the step (1) was subjected to spray drying for 1-2 h under conditions of an inlet temperature of 160-220° C., a spraying air pressure of 0.3 Mpa and a moisture evaporation capacity of 1-200 L/h to remove deionized water so as to obtain a superhydrophobic nanoparticle powder;

16 parts by mass of diatomite, 3 parts by mass of ammonia water, 0.2 part by mass of waterborne perfluorodecyl siloxane, 0.1 part by mass of Evonik DynasylanHydrosil 1151 amino waterborne siloxane were added into 60 parts by mass of deionized water to be stirred for 12 h and then the modified nano powder prepared in the step (2) was added into the mixture to be continuously stirred for 12 h to prepare a impregnated porous powder with superhydrophobic particles suspension, and then the suspension was subjected to spray drying for 1-2 h under conditions of an inlet temperature of 160-220° C., a spraying air pressure of 0.3 Mpa and a moisture evaporation capacity of 1-200 L/h to obtain a final porous powder;

6 parts by mass of the impregnated porous powder with superhydrophobic particles was mechanically stirred and dispersed in 24 parts by mass of butyl acetate, then 8 parts by mass of fluorocarbon resin, 3.2 parts by mass of an aliphatic polyisocyanate curing agent, 0.2 part by mass of polyacrylate as a dispersant, 0.2 part by mass of amino siloxane and 0.15 part by mass of propylene glycol methyl ether acetate as a stabilizer were added, and the mixture was stirred for 10 min to obtain superhydrophobic paint applying the porous powder, and if the fluorocarbon resin and the aliphatic polyisocyanate curing agent were equivalently replaced by epoxy resin and an aliphatic amine curing agent or ceramic paint and the aliphatic polyisocyanate curing agent, paint under different adhesives could be obtained; and

the paint applying the powder prepared in the step (4) was coated to a cleaned surface of any substrate, and the substrate was placed in a 180° C. oven to be heated and dried for 2 h to obtain the superhydrophobic coating.

FIG. 1a shows the impregnated porous powder with superhydrophobic particles suspension, and the powder subjected to spray drying is hydrophilic and can be dispersed in various solvents; and it is superhydrophobic after high temperature drying, and can still be dispersed in the organic solvent to form even paint effectively.

### Example 5

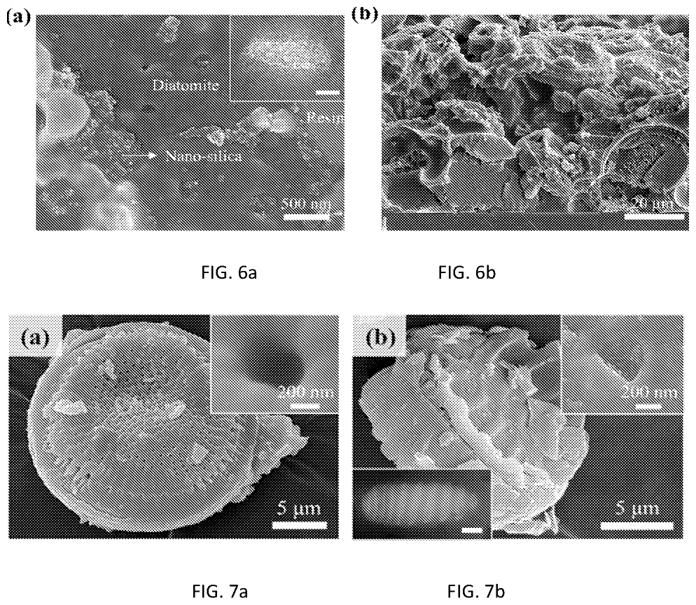

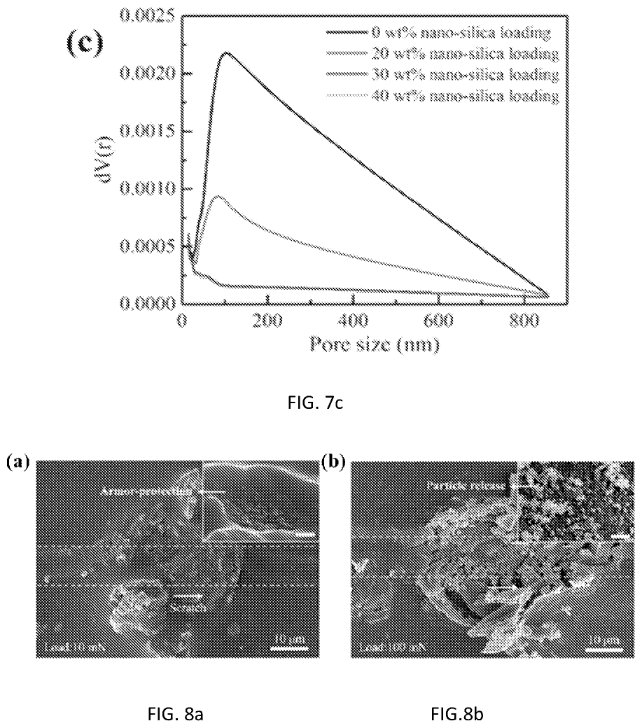

FIG. 6a-b shows surface and section structural diagrams of the superhydrophobic coating applying the impregnated porous powder with superhydrophobic particles in the example 4, and it can be seen from the figure that the superhydrophobic nanoparticles can be successfully stored to pores of porous diatomite. FIG. 7a-c is morphologic diagrams of the porous diatomite particles after and before impregnating and variations of pore diameters of diatomite under conditions of different impregnating capacities. If there are few nanoparticles, the excellent effect achieved by the porous powder impregnating the particles is not prominent, and if there are excessive nanoparticles, they cannot be stored, so that the bonding force between the particles and the adhesive will be reduced, resulting in decline of durability of the coating; the maximum impregnating capacity of used diatomite is 30% through nano silicon sols (chained and spherical nanoparticles are matched) in different shapes via multiple tests, and therefore, the impregnating capacity is controlled precisely.

### Example 6

FIG. 8a-b is an SEM morphologic diagram of nano silicon dioxide stored in the diatomite particles and scratched under different microscopic pressures in the example 1, reflecting the microscopic mechanical performance of the coating. When the load is 10 mN, illustration of the SEM image after scratching shows intact nano silicon dioxide stored in holes of diatomite. There is only a little scratch observed on diatomite, showing that diatomite has enough mechanical strength and a capacity of resisting wear. Diatomite provides nano silicon dioxide with armor protection. When the load is increased to 100 mN, diatomite particles are damaged, and the embedded nano silicon dioxide escapes from hoes and is observed on the surface of the coating, showing that the loss of particle is compensated by self-adaptive release, the damaged area is repaired in real time, and the coating is maintained superhydrophobic.

### Example 7

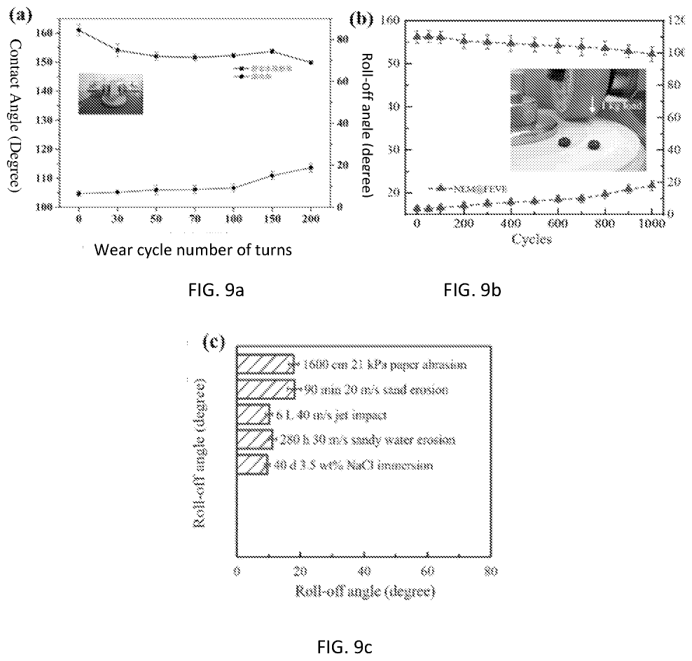

The research group has provided a highly wear-resistant normal temperature cured superhydrophobic coating by integrating superhydrophobic particles and primer and a preparation method previously (a compare document CN110003735 A). In comparison, 4 parts of the final impregnated porous powder with superhydrophobic particles in the example 4 was added into 25 parts by mass of an acetone solution according to a test condition of the example 2 of the compare document CN110003735 A, 0.1 part by mass of an acrylate copolymer was added, the mixture was ultrasonically dispersed for 15 min, then 10 parts by mass of a fluorocarbon resin was added into the mixture to be mechanically stirred for 10 min, 0.5 part by mass of chloridized modified polypropylene, 0.6 part by mass of propylene glycol methyl ether acetate, 0.2 part by mass of hydrogenated castor oil and 0.3 part by mass of dibutyltin dilaurate were added to be stirred for 10 min, and then 2.5 parts by mass of the same fluorocarbon resin curing agent was added to be mechanically and evenly stirred to obtain final paint, and the paint was sprayed to a surface of a glass sample to obtain a final superhydrophobic coating. FIG. 9a shows wear resistance of the coating prepared in the example 2 of the compare document CN110003735 A, and FIG. 9b shows wear resistance of the final coating prepared by the impregnated porous powder with superhydrophobic particles in the example 4 of the present invention. It can be seen that under the same test conditions, the wear resistance is improved by nearly 5 times, and the superhydrophobic coating prepared by the impregnated porous powder with superhydrophobic particles is more excellent in stability performance, and is compact without dusting. The coatings can be maintained superhydrophobic after being subjected to 1 kg load Taber abrasion, RCA tape abrasion, sand ablation, high-pressure water jet impact, high speed sandy water ablation and salt solution immersion. Durability is improved by over 10 times compared with the superhydrophobic coatings, such as commercial Ultra-ever dry coating and Neverwet coating, prepared in the prior art, and the coating can stand against various severe environments.

### Example 8

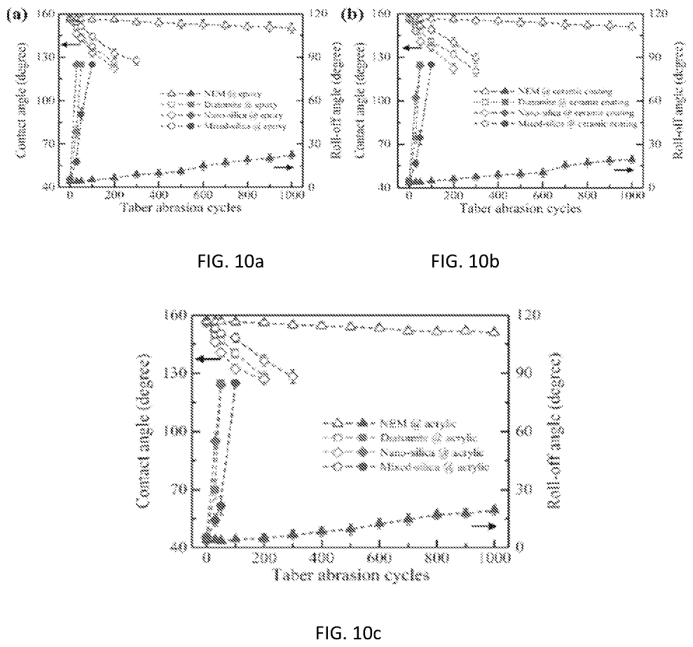

FIG. 10a-c shows universality of the intelligent long-acting superhydrophobic paint prepared by applying the impregnated porous powder with superhydrophobic particles in the example 4. The method can be suitable for various organic resins and inorganic adhesives that are either low surface energy adhesives or non-hydrophobic waterborne adhesives, thereby improving the durability of the superhydrophobic coating remarkably. Through reported superhydrophobic coating technologies, a certain adhesive or a specific adhesive is often preferred to improve the durability of the coating. The limitation is solved effectively due to universality of the present invention.

### Example 9

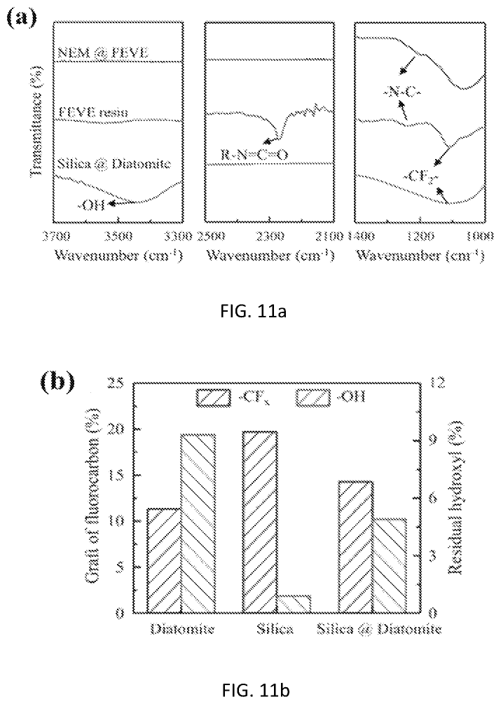

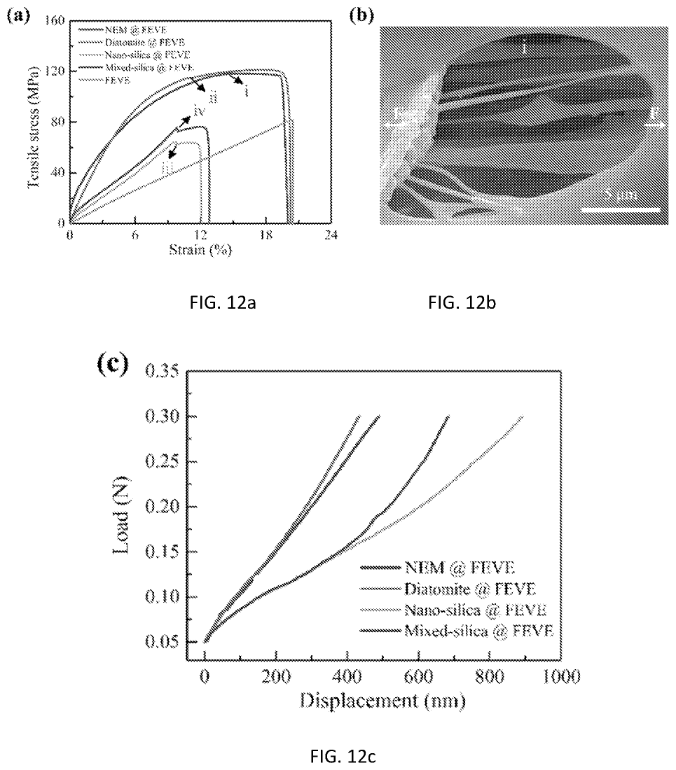

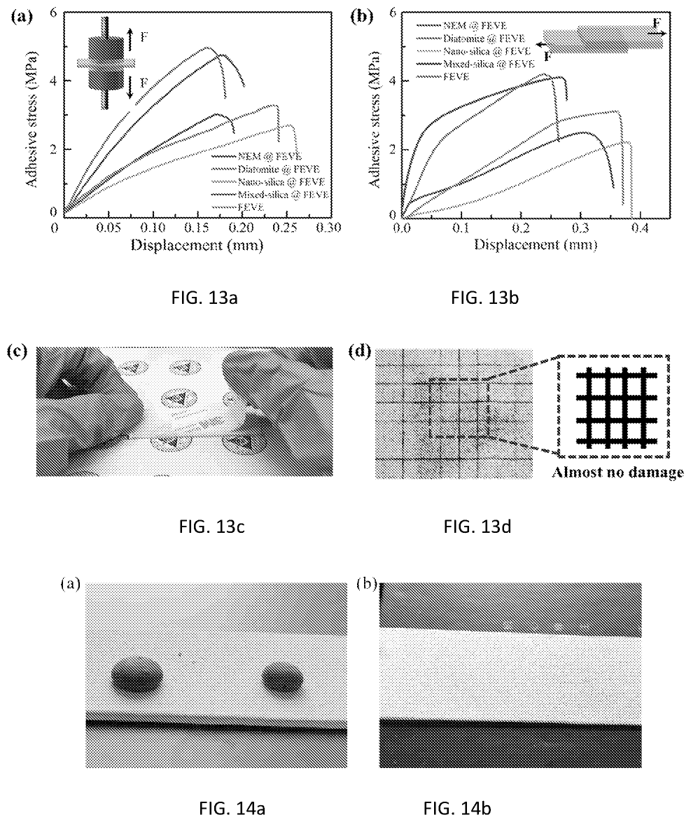

FIG. 11a-b shows an FTIR (Fourier Transform Infrared Spectrometer) of the superhydrophobic coating applying the impregnated porous powder with superhydrophobic particles, the impregnated porous powder with superhydrophobic particles and the fluorocarbon resin in the example 4 as well as fluorine contents and hydroxyl contents of a superhydrophobic nanopowder obtained in the step (1) of the example 4, a microporous powder with a low modification degree obtained in the step (3) of the example 4 by direct spray drying without adding the nanopowder obtained in the step (1) and the final impregnated porous powder with superhydrophobic particles obtained in the example 4. After the fluorocarbon resin coatings the impregnated porous powder with superhydrophobic particles, —OH and —N═C═O peaks disappear and —N—C peaks are enhanced, showing that the resin and the impregnated porous powder with superhydrophobic particles are bonded successfully. It can be seen via a fluorine grafting amount and a hydroxyl residual amount that residual hydroxyl of silicon dioxide is 10 times lower than that of the micro porous powder with the low degree of modification, so that it is superhydrophobic after high temperature drying. The micro porous powder with the low degree of modification provides hydroxyl capable of being tightly bonded with the resin and the substrate. A pulverizing process or a pulping process is controlled, so that the prepared powder or slurry retains part of active groups, so that it is hydrophilic, and therefore, it is convenient to improve the dispersibility in the film forming matter. By regulating and controlling the degree of modification precisely, the fluorine contents and hydroxyl contents of the final impregnated porous powder with superhydrophobic particles are in optimal ranges. FIG. 12 shows mechanical performance of the superhydrophobic coating prepared by applying the impregnated porous powder with superhydrophobic particles. Compared with used adhesive and common superhydrophobic coating, the superhydrophobic of the superhydrophobic coating is improved by 55-100%, and the ductility is improved by about 66.7% compared with that of the common superhydrophobic coating. After it is stretched to yield strength, the adhesive is still adhered to the surface of the porous powder in a drawing state, thereby providing a beneficial effect to improving the tensile strength. Besides, the compressive mechanical property of the superhydrophobic coating is also remarkably improved compared with that of the common superhydrophobic coating, including hardness, Young modulus and the like. FIG. 13 shows an adhesive strength of the superhydrophobic coating prepared by applying the impregnated porous powder with superhydrophobic particles. The tangential adhesive strength and the normal adhesive strength of the superhydrophobic coating are improved by 50% or above compared with those of the adhesive and the common superhydrophobic coating. A grid adhesive strength test is performed according to an ISO 2409 standard, the adhesive strength of a used tape on the coating is not lower than (10+−) N/25 mm, and it can be found that the coating does not fall off, is adhered 100% and reaches the grade 0 in the standard.

### Example 10

In the embodiment, inorganic nanoparticles are titanium dioxide, a volatile organic solvent is acetone, a hydrophobic modifier is propyl trimethoxysilane and Evonik Protectosil WS 670, and porous microparticles are porous silicon dioxide. The preparation method includes the following preparation steps:

10 parts by mass of a titanium dioxide sol, 6 parts by mass of ammonia water, 0.3 part by mass of propyl trimethoxysilane and 0.8 part by mass of Evonik Protectosil WS 670 were dispersed in 100 parts by mass of deionized water to be continuously stirred for 24 h to prepare a modified nanoparticle suspension;

a supernate was filtered when the superhydrophobic nano paint prepared in the step (1) centrifugalized by a 6000 r centrifugal machine to remove deionized water, and the coating was dried for 1 h in a vacuum drying box to obtain a superhydrophobic modified nanoparticle powder;

8 parts by mass of porous silicon dioxide, 0.3 part by mass of Evonik DynasylanHydrosil 1151 amino waterborne siloxane were added into 80 parts by mass of deionized water to be stirred for 12 h and then the modified nanoparticle powder prepared in the step (2) was added into the mixture to be continuously stirred for 12 h to prepare a superhydrophobic particle impregnating porous particle suspension, and then the suspension was subjected to spray drying for 1-2 h under conditions of an inlet temperature of 160-220° C., a spraying air pressure of 0.3 Mpa and a moisture evaporation capacity of 1-200 L/h to obtain a final porous powder;

6 parts by mass of the impregnated porous powder with superhydrophobic particles was mechanically stirred and dispersed in 30 parts by mass of acetone, then 12 parts by mass of epoxy resin, 2 parts by mass of a closed polyisocyanate curing agent, 0.5 parts by mass of polyacrylate as a dispersant, 0.4 part by mass of amino siloxane and 0.3 part by mass of propylene glycol methyl ether acetate as a stabilizer were added, and the mixture was stirred for 15 min to obtain superhydrophobic paint applying the porous powder; and

the paint applying the impregnated porous powder with superhydrophobic particles prepared in the step (4) was coated to a cleaned surface of any substrate, and the substrate was placed in a 220° C. oven to be heated and dried for 2 h to obtain the superhydrophobic coating.

FIG. 13a shows the impregnated porous powder with superhydrophobic particles suspension, and the powder subjected to spray drying is hydrophilic and can be fully dispersed in various solvents to form even paint.

### Example 11

FIG. 14a-b shows a scale prevention property of the intelligent long-acting superhydrophobic paint prepared by applying the impregnated porous powder with superhydrophobic particles in the example 10. The used cement slurry is spherical on the surface of the coating and cannot be unfolded, showing the scale prevention property of the coating. When the coating is inclined, the solidified cement slurry falls off naturally under the action of gravity, and the surface of the coating is still kept in an initial state.

### Example 12

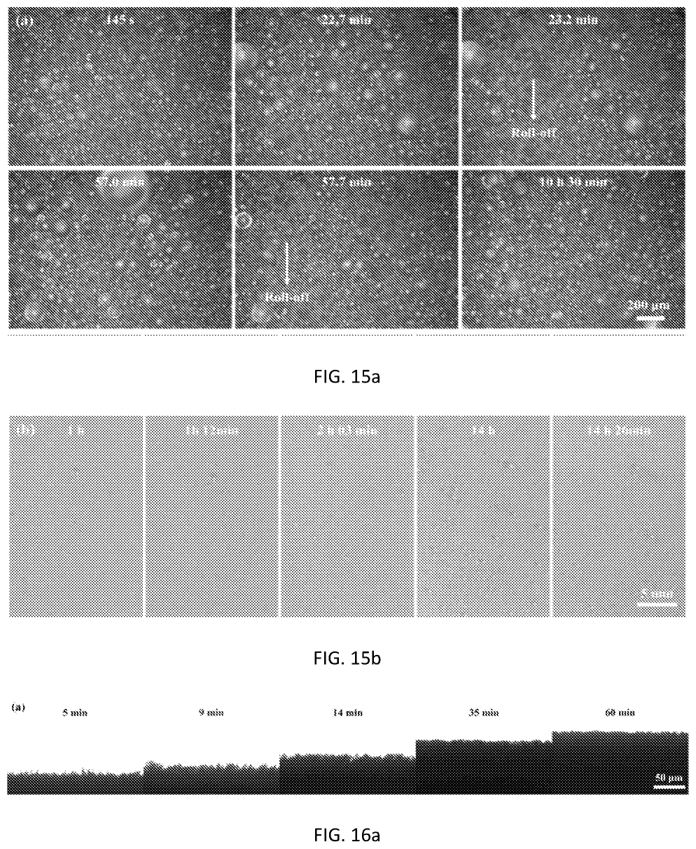

FIG. 15a-b shows an anti-condensation property of the superhydrophobic coating prepared by applying the impregnated porous powder with superhydrophobic particles in the example 10. When condensate dewdrops are solidified, they are spherical, few and low in coverage. Along with growth of the condensate dewdrops, under the action of gravity, the condensate dewdrops easily roll away from the surface of the coating and take away the condensate dewdrops on the way, so that the coverage of the condensate dewdrops is greatly reduced. As time goes on, the exposed dried area will be subjected to continuous condensation and self-removal to achieve a dynamic balance, so that the coverage of the condensate dewdrops on the surface of the coating is maintained at a low level all the time.

### Example 13

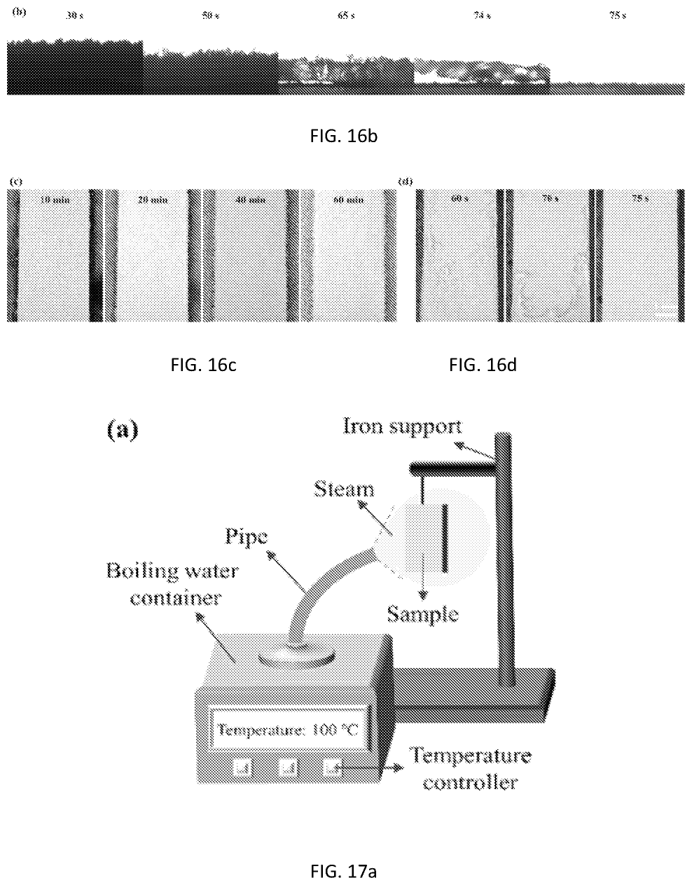

FIG. 16a-d shows a frosting prevention property of the superhydrophobic coating applying the impregnated porous powder with superhydrophobic particles in the example 10. The initial growth speed of a frost layer is low. The surface of the coating has the obvious frost layer till it is condensed for 20 min, and the frosting behavior is inhibited obviously. When frost is melted, the whole frost layer rolls up and falls off, and the defrosting speed is high; and after defrosting, the surface is dry and is free of any residues. An excellent frosting prevention property is shown.

### Example 14

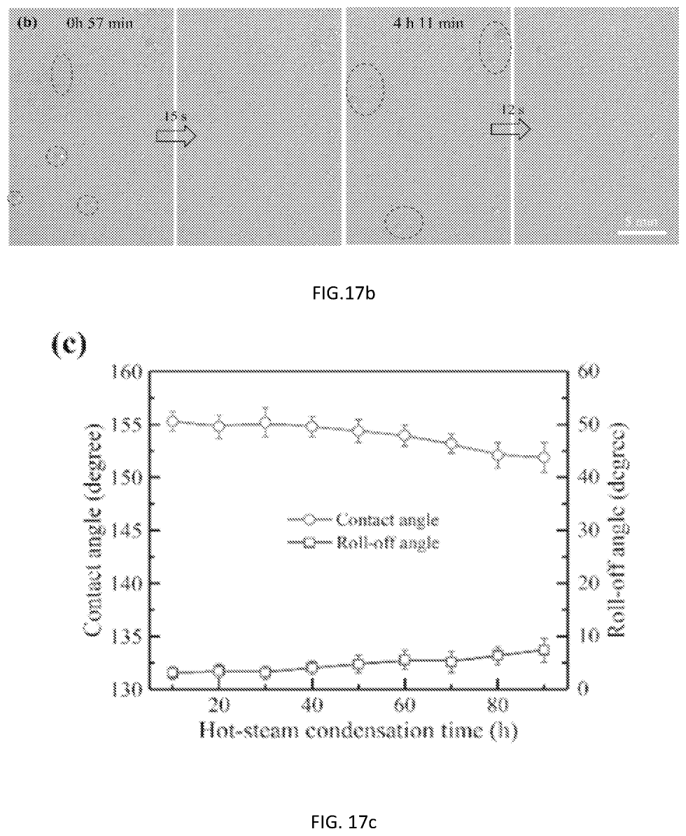

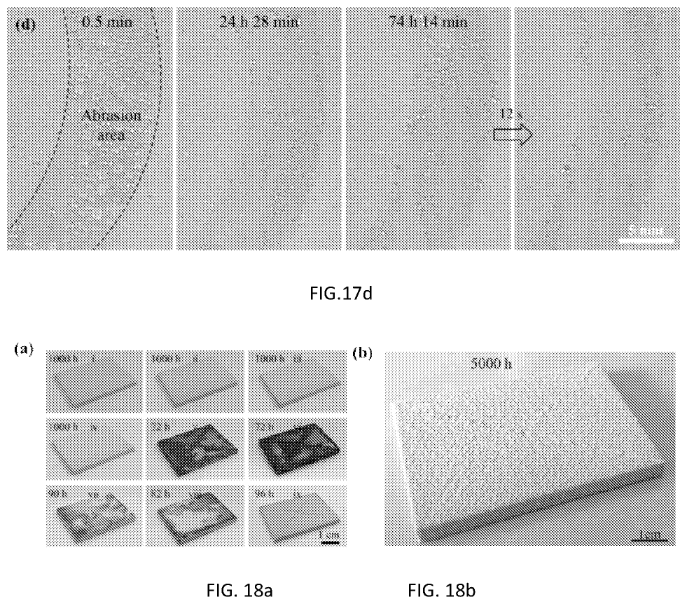

FIG. 17a-d shows a dropwise condensation property of hot water vapor of the superhydrophobic coating prepared by applying the impregnated porous powder with superhydrophobic particles in the example 10. When hot water vapor liquid drops are solidified, they are spherical, low in forming speed and low in coverage. Along with growth of the condensed liquid drops, under the action of gravity, the liquid drops easily roll away from the surface of the coating and take away the liquid drops on the way. As time goes on, the liquid drops will be condensed continuously and roll away to achieve a dynamic balance, so that the coverage of the liquid drops on the surface of the coating is maintained at a low level all the time. A lot of liquid drops will be condensed on the surface of the coating at the beginning after a load is applied to wear, but the hot water vapor liquid drops are still spherical when being condensed. As time goes, they will achieve a dynamic balance state again, so that the surface of the coating maintains low liquid drop coverage.

### Example 15

FIG. 18a-b shows a salt-spray corrosion effect of the superhydrophobic coating prepared by applying the impregnated porous powder with superhydrophobic particles in the example 4. i-iv are the superhydrophobic coating applying the impregnated porous powder with superhydrophobic particles prepared by different adhesives, v and vi are fluorocarbon resin and epoxy resin coatings, and vii-ix are comparative superhydrophobic coatings, and vii-ix are comparative superhydrophobic coatings; the surface of the superhydrophobic coating applying the impregnated porous powder with superhydrophobic particles still has no rust in 1000 h, and shows excellent salt spray corrosion resistance in various adhesives. When the time is 5000 h, the roll-off angle of the coating is still smaller than 20°, and the surface of the sample is free of rust.

### Example 16

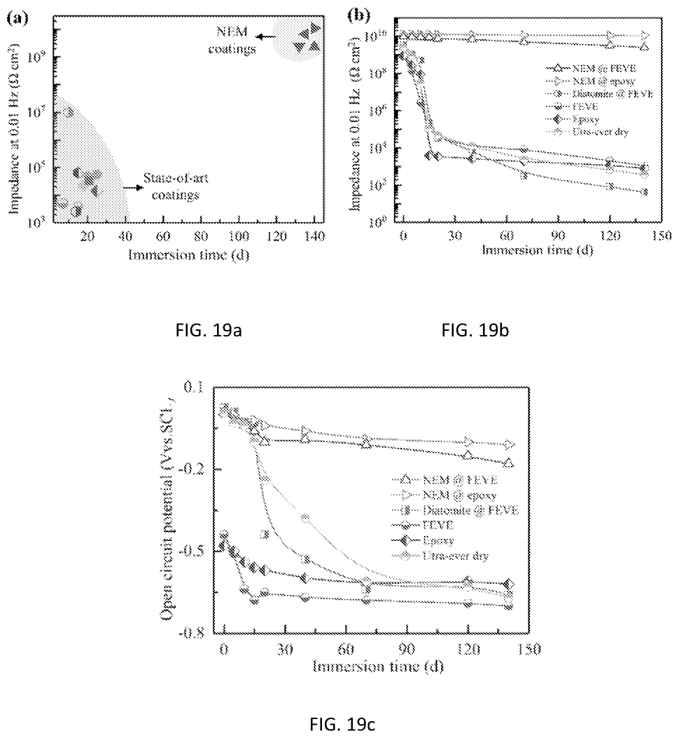

FIG. 19a-c shows a salt solution immersion resisting effect of the superhydrophobic coating prepared by applying the impregnated porous powder with superhydrophobic particles in the example 4. compared with anti-corrosive coatings in the market (for example, epoxy resin and fluorocarbon resin coatings) and common superhydrophobic coatings such as Ultra-ever dry and Neverwet coatings, the low frequency modulus of impedance of the superhydrophobic coating is improved by several orders of magnitudes, and the anti-corrosive time thereof is also prolonged by more than 10 times; besides, the open circuit potential of the superhydrophobic coating is kept stable all the time as the salt solution immersion time is prolonged, and the open circuit potentials of other coatings are reduced remarkably.

### Example 17

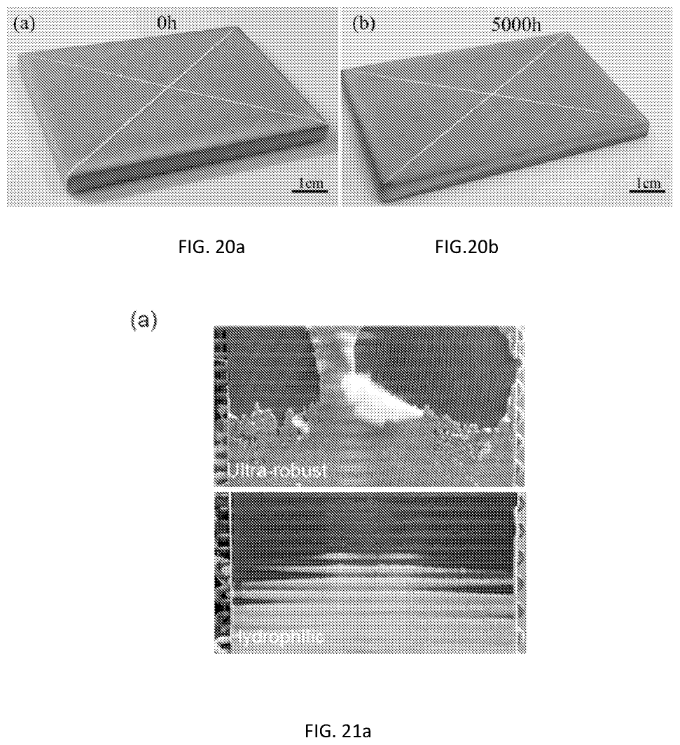

FIG. 20a-b is macroscopic morphologic diagrams of an anti-corrosive hydrophobic coating prepared by applying the impregnated porous powder with superhydrophobic particles prepared by a wet spraying process after and before anti-salt-spray corrosion, with fluorocarbon resin and the curing agent thereof are equivalently replaced by epoxy resin and the curing agent, by using the paint in the example 4. A compact structure is formed on the surface of the coating by epoxy resin to protect a substrate, and the impregnated porous powder with superhydrophobic particles is evenly dispersed in the coating to block permeation of external salt spray. Compared with the corrosion resistance of the pure epoxy resin coating, the corrosion resistance of the coating is improved by nearly 100 times. The surface of the sample is still free of rust in 5000 h of salt spray.

### Example 18

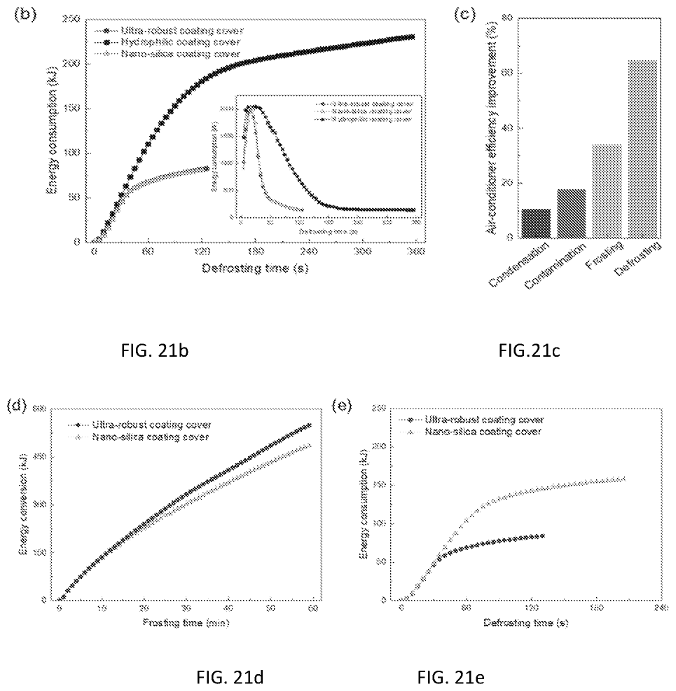

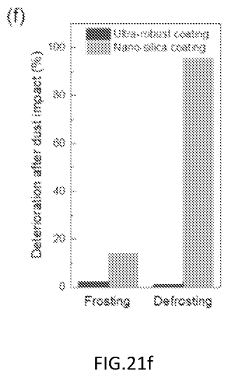

FIG. 21a-f shows a defrosting property of the superhydrophobic coating prepared by applying the impregnated porous powder with superhydrophobic particles in the example 10. Compared with conventional commercially used hydrophilic coating heat exchangers, the defrosting process of a superhydrophobic coating heat exchanger prepared by applying the impregnated porous powder with superhydrophobic particles is more rapid in process with frost layers falling in block and is free of water drop residues; the defrosting energy consumption of the superhydrophobic coating prepared by applying the impregnated porous powder with superhydrophobic particles is lower compared with that of the nano superhydrophobic coating and the commercial hydrophilic coating, and under different working conditions such as condensation, dust contamination, frost formation and defrosting, the efficiencies are higher; in a dust blowing test, damage conditions caused by pollution and sand dust under actual working conditions are simulated. Compared with the nano superhydrophobic coating heat exchanger, the frosting heat exchange amount of the heat exchanger with the superhydrophobic coating prepared by applying the impregnated porous powder with superhydrophobic particles is higher and the defrosting energy consumption thereof is lower. The efficiency attenuation ratio of the heat exchanger after dust blowing is lower, showing breakthrough innovation and long action of the superhydrophobic coating prepared by applying the impregnated porous powder with superhydrophobic particles.

The above examples are merely the preferred embodiments of the present invention. It shall be pointed out that those of ordinary skill in the technical field can made several improvements without departing the principle of the present invention, and these improvements shall be made within the protection range of the present invention.

What is claimed is:

1. A method for preparing an impregnated porous powder with superhydrophobic particles, comprising the following steps:
i) dispersing 1-12 parts by mass of a nanoparticle sol, 2-10 parts by mass of ammonia water and 1-2 parts by mass of a waterborne hydrophobic treatment agent in 60-100 parts by mass of deionized water and performing constant stirring for 12-48 h to prepare a modified nanoparticle suspension, and obtaining a superhydrophobic modified nanoparticle powder by means of a spray drying process, wherein the nanoparticle sol is at least one of an aluminum oxide nanoparticle sol, a titanium dioxide nanoparticle sol and a silicon dioxide nanoparticle sol with a particle size of 1-200 nm, a solid content of 15-30 wt. % and a pH value of 8-9; and the waterborne hydrophobic treatment agent is one of a waterborne perfluorodecyl siloxane oligomer or a waterborne propyloctyl siloxane oligomer or an emulsion formed by mixing alkyl siloxane with a cationic or nonionic perfluoroacrylic surfactant, a mixing mass ratio of alkyl siloxane to the surfactant is (1-3):1; and
ii) adding 1-18 parts by mass of a porous ceramic micro-powder and 0.1-0.5 part by mass of a waterborne silane coupling agent into 60-100 parts by mass of deionized water or adding 1-18 parts by mass of a porous micron ceramic powder, 2-10 parts by mass of ammonia water, 0.4-1 part by mass of a waterborne hydrophobic treatment agent and 0.1-0.5 part by mass of a waterborne silane coupling agent into 60-100 parts by mass of deionized water, performing constant stirring for 12-48 h, then adding 1-5 parts by mass of the superhydrophobic modified nanoparticle powder obtained in the step (1), and performing constant stirring for 12-48 h to prepare a superhydrophobic particle impregnating porous particle suspension, and obtaining the impregnated porous powder with superhydrophobic particles by means of a filter drying process or the spray drying process, wherein the waterborne silane coupling agent is Evonik DynasylanHydrosil 1151 amino waterborne siloxane, and the porous ceramic micro-powder is at least one of diatomite particles, silicon dioxide particles, aluminum oxide particles and zirconium oxide particles with a particle size of 1-75 m, or porous ceramic particles prepared by performing high-temperature sintering by taking the diatomite particles, silicon dioxide particles, aluminum oxide particles and zirconium oxide particles as a raw material.

2. The method according to claim 1, wherein the nanoparticle sol is at least one of the aluminum oxide nanoparticle sol, the titanium dioxide nanoparticle sol and the silicon dioxide nanoparticle sol with a particle size of 1-200 nm, a solid content of 15-30 wt. % and a pH value of 8-9; and the modified nanoparticle suspension can further be one of nanoparticle emulsions containing polytetrafluoroethylene, polystyrene, polypropylene or high density polyethylene with a solid content of 30 wt. % and a pH value of 8-9.

3. The method according to claim 1, wherein the filter drying refers to suction filtration of the porous particle suspension under a condition of a vacuum degree of 0.02 MPa or centrifugal separation of the porous particle suspension at a rotating speed of 6000 rpm, and drying of filtered slurry for 1-2 h at 80-120° C.; and the spray drying process refers to spray drying for 1-2 h under conditions of an inlet temperature of 160-220° C., a spraying air pressure of 0.3 Mpa and a moisture evaporation capacity of 1-200 L/h.

4. The method according to claim 1, wherein the waterborne perfluorodecyl siloxane is Evonik Dynasylan F8815, the waterborne propyloctyl siloxane oligomer is Evonik Protectosil WS 670, alkyl siloxane can be any one of tridecafluorotriethoxy silane, isobutyltriethoxy silane or proyltriethoxy silane, and the waterborne silane coupling agent is Evonik DynasylanHydrosil 1151 amino waterborne silane.

5. The method according to claim 1, wherein the porous ceramic micro-powder is flaky, columnar, disciform or spherical with a pore diameter of 20 nm to 2 m, a specific surface area of 40-200 m²/g and a pore volume of 0.08-1.2 cm³/g.

6. The method according to claim 5, wherein the particle size is 1-75 m, the specific surface area is 10-80 m²/g and the pore volume is 0.02-0.6 cm³/g, and the dried powder is hydrophilic and is superhydrophobic if being heated for 1-2 h at 150-250° C.

7. A process for preparing paint or coatings comprising a step of using the impregnated porous powder with superhydrophobic particles of claim 6 in preparation of the paint or coatings.

8. The process according to claim 7, wherein the process further comprising the following preparation steps:
i) oily or waterborne paint: mechanically stirring and dispersing 0.1-10 parts by mass of an impregnated porous powder with superhydrophobic particles in 10-30 parts by mass of a volatile organic solvent or deionized water; upon preparation of the waterborne paint: directly using 1-40 parts by mass of an impregnated porous powder with superhydrophobic particles, then adding 2-10 parts by mass of a film forming matter, 1-4 parts by mass of a curing agent and 0.05-0.4 part by mass of an acrylate copolymer as a dispersant, 0.1-0.5 part by mass of an adhesion promoter, 0.1-0.5 part by mass of a silane coupling agent and 0.1-0.5 part by mass of propylene glycol methyl ether acetate as a stabilizer, and mechanically stirring the mixture for 10 min to obtain the superhydrophobic paint; and coating any cleaned substrate surface with the superhydrophobic coating by way of spraying, dip-coating, roller coating or brush coating, and placing the substrate in an oven at 150-250° C. to be heated and dried for 1-2 h to obtain a superhydrophobic coating, wherein the volatile organic solvent is at least one of ketone, alcohol, ester, fluorocarbon and ether; the film forming matter is at least one of a fluorocarbon resin with low surface energy, organic silicon and a modified resin thereof or a non-hydrophobic acrylic resin, epoxy resin, polyurethane resin, ceramic bond, waterborne acrylic resin or waterborne polyurethane resin; the adhesion promoter is at least one of amino siloxane, alkyl siloxane or a methyl siloxy copolymerized resin; the acrylate copolymer is at least one of polyacrylate, an alkyl acrylate copolymer and an acrylate-acrylic acid copolymer; one end of the silane coupling agent is amino and the other end thereof is ethoxyl or methoxyl; and the curing agent is at least one of isocyanate, fatty amine, aromatic amine and acylamino amine;
ii) powder paint: putting 0.1-10 parts by mass of a impregnated porous powder with superhydrophobic particles and 2-8 parts by mass of a binder powder in a ball mill to be ball-milled, putting the powders into a mold to be heated and melted, and performing pulverization for 5-10 min by using a multifunctional pulverizer after cooling to obtain superhydrophobic powder paint with a size of 15-48 m; and electrostatically spraying the prepared powder to a metal substrate, putting the metal substrate in the oven to be cured at a high temperature of 150-250° C. for 10-20 min, and cooling the metal substrate to room temperature to obtain the superhydrophobic coating, wherein the binder powder is at least one of a polyester resin powder, an epoxy resin powder, a polyurethane resin powder and a fluorocarbon resin powder, and the ball milling refers to putting the mixed powders in a ball-milling tank, then adding zirconium oxide ball-milling beads with particle sizes of 1-1.4 mm and performing ball-milling for 4-12 h with a rotating speed of the ball mill being kept at 30-300 r/min; and
iii) electrophoretic paint: diluting 2-10 parts by mass of electrophoretic paint 5-10 times with deionized water, adding 0.1-10 parts by mass of an impregnated porous powder with superhydrophobic particles into the solution by taking 0.05-0.4 part by mass of an acrylate copolymer as a dispersant, mechanically stirring the solution for 30 min, performing electrophoretic deposition for 10-30 min at a condition of a direct current voltage of 30-40 V, and then putting the mixture in the oven at 150-250° C. to be heated and dried for 1-2 h to obtain the superhydrophobic coating, wherein the electrophoretic paint is at least one of epoxy electrophoretic paint, acrylic electrophoretic paint and polyurethane electrophoretic paint; and the acrylate copolymer is at least one of polyacrylate, an alkyl acrylate copolymer and an acrylate-acrylic acid copolymer.
